(19) United States
(12) Patent Application Publication
(10) Pub. No.: US 2026/0213162 A1
(43) Pub. Date: Jul. 23, 2026

(54) NEGATIVE ELECTRODE ACTIVE MATERIAL COMPOSITE PARTICLES, METHOD FOR THEIR PRODUCTION, NEGATIVE ELECTRODE MIXTURE, AND BATTERY

(71) Applicant: TOYOTA JIDOSHA KABUSHIKI KAISHA, Toyota-shi (JP)

(72) Inventor: Satoshi Mizutani, Okazaki-shi (JP)

(73) Assignee: TOYOTA JIDOSHA KABUSHIKI KAISHA, Toyota-shi (JP)

(21) Appl. No.: 19/399,879

(22) Filed: Nov. 25, 2025

(30) Foreign Application Priority Data
Jan. 22, 2025 (JP) 2025-009239

(51) Int. Cl. H01M 4/36; H01M 4/02; H01M 4/38; H01M 4/587

(52) U.S. Cl. CPC H01M 4/364; H01M 4/387; H01M 4/587; H01M 2004/021

(57) ABSTRACT

The present disclosure provides negative electrode active material composite particles that can inhibit volume changes in a battery, as well as a method for producing them, a negative electrode mixture comprising the negative electrode active material composite particles, and a battery comprising the negative electrode mixture. The negative electrode active material composite particles of the disclosure comprise a carbon material and a tin alloy supported in the carbon material. The negative electrode active material composite particles of the disclosure have pores. The aspect ratio of the negative electrode active material composite particles of the disclosure is 1.60 or lower, and the d90 is 10.0 μm or less.

### FIELD

The present disclosure relates to negative electrode active material composite particles and a method for producing them, as well as to a negative electrode mixture and a battery.

### BACKGROUND

As disclosed in PTLs 1 and 2, negative electrode materials are known that comprise elements (such as tin) capable of producing alloys with lithium or intermetallic compounds, and carbon materials, for improved battery cycle characteristics.

When silicon or tin is used as the negative electrode active material, the negative electrode active material undergoes expansion and contraction with charge-discharge of the battery, resulting in changing volume of the battery. In order to reduce such volume changes, techniques have been developed for forming voids (pores) in the negative electrode mixture layer, as disclosed in PTL 3.

### CITATION LIST

### Patent Literature

[PTL 1] International Patent Publication No. WO2004/100291
[PTL 2] International Patent Publication No. WO2004/100293
[PTL 3] Japanese Unexamined Patent Publication No. 2017-010802

### SUMMARY

### Technical Problem

Negative electrode active material composite particles comprising a carbon material and a tin alloy, such as disclosed in PTL 1, are in need of improvement from the viewpoint of reducing changes in volume.

It is an object of the present disclosure to provide negative electrode active material composite particles that can inhibit volume changes in a battery, as well as a method for producing them, a negative electrode mixture comprising the negative electrode active material composite particles, and a battery comprising the negative electrode mixture.

### Solution to Problem

The present inventors have found that the aforementioned object can be achieved by the following means.

### <Aspect 1>

Negative electrode active material composite particles comprising a carbon material and a tin alloy supported in the carbon material,
wherein the negative electrode active material composite particles have pores,
the aspect ratio of the negative electrode active material composite particles is 1.60 or lower, and
the d90 is 10.0 μm or smaller.

### <Aspect 2>

The negative electrode active material composite particles according to aspect 1, wherein the aspect ratio is 1.00 to 1.60, and
the d90 is 1.0 μm to 10.0 μm.

### <Aspect 3>

A negative electrode mixture comprising negative electrode active material composite particles according to aspect 1 or 2.

### <Aspect 4>

A battery,
having a negative electrode active material layer,
wherein the negative electrode active material layer comprises a negative electrode mixture according to aspect 3.

### <Aspect 5>

A method for producing negative electrode active material composite particles according to aspect 1 or 2, the method comprising the following steps:
mixing the carbon material, tin, a metal that forms an alloy with tin, as well as metal silicon and/or silicon oxide by a mechanical alloying method, to obtain a negative electrode active material composite particle precursor, and
contacting the negative electrode active material composite particle precursor with an alkaline solution to elute out the metal silicon and/or silicon oxide, thereby forming pores.

### Advantageous Effects of Invention

The present disclosure can provide negative electrode active material composite particles that can inhibit volume changes in a battery, as well as a method for producing them, a negative electrode mixture comprising the negative electrode active material composite particles, and a battery comprising the negative electrode mixture.

### BRIEF DESCRIPTION OF DRAWINGS

FIG. 1A shows a schematic diagram of the carbon-tin alloy complex.

FIG. 1B shows a schematic diagram of the negative electrode active material composite particle precursor.

FIG. 1C shows a schematic diagram of the negative electrode active material composite particles.

FIG. 2 is a simplified cross-sectional view showing an example of a battery of the disclosure.

### DESCRIPTION OF EMBODIMENTS

An embodiment of the disclosure will now be described in detail. The disclosure is not limited to the embodiment described below, however, and various modifications may be implemented which do not depart from the gist thereof.

### <Negative Electrode Active Material Composite Particles>

The negative electrode active material composite particles of the disclosure comprise a carbon material and a tin alloy supported in the carbon material. The negative electrode active material composite particles of the disclosure have pores. The aspect ratio of the negative electrode active material composite particles of the disclosure is 1.60 or lower, and the d90 is 10.0 μm or less.

The present inventors have found, unexpectedly, that in negative electrode active material composite particles in which the carbon material supports a tin alloy and which have pores, limiting the aspect ratio and d90 so that both are at or below specified values allows volume change in the battery to be suppressed.

The elements composing the negative electrode active material composite particles of the disclosure will now be described.

### <Carbon Material>

The negative electrode active material composite particles of the disclosure comprise a carbon material. The carbon material functions as a parent material which supports the tin alloy inside it. If the negative electrode active material composite particles comprise a carbon material, it is possible to lower the crystallinity of the tin alloy, thereby allowing the tin alloy to smoothly occlude and detach carrier ions. The carbon material may be amorphous, in which case the carbon material does not need to contribute to charge-discharge of the battery.

The starting material for the carbon material is not particularly restricted, and examples include non-graphitizable carbon, graphitizable carbon, graphite, pyrolytic carbon, coke, glassy carbon, fired organic polymer compounds, active carbon and carbon black, as well as combinations of the foregoing.

The carbon material content is not particularly restricted and may be 10 mass % or higher, 11 mass % or higher, 12 mass % or higher, 13 mass % or higher, 14 mass % or higher or 15 mass % or higher, and 30 mass % or lower, 28 mass % or lower, 26 mass % or lower, 24 mass % or lower, 22 mass % or lower or 20 mass % or lower, for example.

The carbon material content can be quantified by a combustion method using a carbon/sulfur analyzer (CS meter), for example.

### <Tin Alloy>

The negative electrode active material composite particles of the disclosure comprise a tin alloy supported in a carbon material. The tin alloy has the function of storing and desorbing carrier ions such as sodium ion, and thus contributes to charge-discharge of the battery. The tin alloy expands and contracts during charge-discharge of the battery.

The tin alloy may be an alloy containing tin and at least one metal selected from among cobalt, iron, copper and nickel.

The tin alloy content and composition are not particularly restricted. For example, the tin alloy can be quantified by energy dispersive fluorescent X-ray spectroscopy (EDX) and high-frequency inductively coupled plasma (ICP) emission spectroscopy.

The half-width of the tin alloy in the XRD spectrum is not particularly restricted, and may be 0.3° or greater, 0.5° or greater, 0.7° or greater, 1.0° or greater, 1.5° or greater, 2.0° or greater or 3.0° or greater, and 10.0° or less, 8.0° or less, 6.0° or less or 5.0° or less, for example. The XRD spectrum may be, for example, a diffraction peak obtained by X-ray diffraction using CuKα rays as the specific X-rays, with the sweep rate set to 1°/min. The half-width of the tin alloy in the XRD spectrum can be evaluated as the half-width of the peak near 2θ=45°. The half-width of the tin alloy in the XRD spectrum can also be evaluated in the discharged state, i.e. in a state without insertion of a carrier ion.

### <Pores>

The negative electrode active material composite particles of the disclosure have pores. This can alleviate expansion and contraction of the tin alloy that occurs with charge-discharge of the battery.

The proportion of the volume of the pores in the negative electrode active material composite particles is not particularly restricted and may be 1 vol % or greater, 3 vol % or greater, 5 vol % or greater, 8 vol % or greater, 9 vol % or greater or 10 vol % or greater, and 30 vol % or lower, 25 vol % or lower, 20 vol % or lower, 15 vol % or lower, 13 vol % or lower, 12 vol % or lower or 11 vol % or lower, for example.

The mean diameter of the pores is not particularly restricted and may be 0.1 μm or larger or 0.2 μm or larger, and 1.0 μm or smaller, 0.8 μm or smaller, 0.6 μm or smaller or 0.4 μm or smaller, for example.

The volume proportion and mean diameter of the pores can be measured by mercury porosimetry, for example.

### <Aspect Ratio>

The aspect ratio of the negative electrode active material composite particles of the disclosure is 1.60 or lower.

The aspect ratio may be 0.10 or higher, 0.50 or higher, 0.80 or higher, 1.00 or higher, 1.10 or higher, 1.15 or higher, 1.20 or higher, 1.25 or higher, 1.30 or higher, 1.35 or higher or 1.40 or higher, and 1.50 or lower, 1.45 or lower, 1.40 or lower, 1.35 or lower, 1.30 or lower, 1.25 or lower, 1.20 or lower or 1.15 or lower. This will allow volume change of the battery to be effectively reduced.

The aspect ratio can be calculated, for example, by dividing the longest width among the widths between the mutually opposite particle edges of each of the negative electrode active material composite particles, by the shortest width, for multiple particles in a cross-sectional SEM image of the particles.

<d90>

The d90 of the negative electrode active material composite particles of the disclosure is 10.0 μm or less.

The value of d90 may be 0.1 μm or greater, 0.5 μm or greater, 1.0 μm or greater, 1.5 μm or greater, 2.0 μm or greater, 2.5 μm or greater, 3.0 μm or greater or 3.5 μm or greater, and 5.0 μm or less, 4.5 μm or less, 4.0 μm or less, 3.5 μm or less, 3.0 μm or less, 2.5 μm or less, 2.0 μm or less or 1.5 μm or less. The value of d90 may be 1.0 μm to 10.0 μm, 1.5 μm to 5.0 μm or 1.5 μm to 4.0 μm. This will allow volume changes of the battery to be effectively reduced.

The d90 value can be calculated from the particle size distribution measured by laser diffraction using a SALD7500 by Shimadzu Corp., for example.

The aspect ratio of the negative electrode active material composite particles may be 1.00 to 1.60, 1.10 to 1.45 or 1.10 to 1.40, and d90 may be 1.0 μm to 10.0 μm, 1.5 μm to 5.0 μm or 1.5 μm to 4.0 μm. This will allow volume changes of the battery to be effectively reduced.

### <Metal Silicon, Silicon Oxide and Silicon Carbide>

The negative electrode active material composite particles may further comprise one or more from among metal silicon, silicon oxide and silicon carbide. As explained below, metal silicon and/or silicon oxide can be eluted from the negative electrode active material composite particle precursor with an alkaline solution to form pores. Therefore, the metal silicon and silicon oxide may be the non-eluted residue remaining after elution with an alkaline solution. The term “silicon oxide” refers particularly to silicon dioxide (SiO₂). The silicon carbide may be one produced from metal silicon.

There are no particular restrictions on the method of detecting the metal silicon, silicon oxide and silicon carbide. Metal silicon can be detected by energy dispersive fluorescent X-ray spectroscopy (EDX) and high-frequency inductively coupled plasma (ICP) emission spectroscopy, for example. Silicon oxide can be detected, for example, by infrared absorption, acid dissolution or ICP-AES. The silicon carbide can be detected by X-ray diffraction (XRD).

There are no particular restrictions on the content of the metal silicon, silicon oxide and silicon carbide.

### <Method for Producing Negative Electrode Active Material Composite Particles>

The method of the disclosure for producing negative electrode active material composite particles comprises the following steps:
mixing a carbon material, tin, a metal that forms an alloy with tin, and metal silicon and/or silicon oxide by a mechanical alloying method, to obtain a negative electrode active material composite particle precursor, and
contacting the negative electrode active material composite particle precursor with an alkaline solution to elute out the metal silicon and/or silicon oxide, thereby forming pores.

In the step of obtaining the negative electrode active material composite particle precursor by mixing the carbon material, the tin, the metal that forms an alloy with tin and the metal silicon and/or silicon oxide by mechanical alloying, the components may be mixed in any desired order.

Specifically, for example, the metal forming the carbon material, the tin and the metal that forms an alloy with tin may be mixed by mechanical alloying, after which the metal silicon and/or silicon oxide may be further added to the obtained carbon-tin alloy complex and further mixed by mechanical alloying to obtain a negative electrode active material composite particle precursor.

In other words, the negative electrode active material composite particles of the disclosure may be produced by a method comprising the following steps:
(a) the carbon material, the tin and the metal that is to form the alloy with tin are mixed by a mechanical alloying method to obtain a carbon-tin alloy complex;
(b) the carbon-tin alloy complex and the metal silicon and/or silicon oxide are mixed by mechanical alloying to obtain a negative electrode active material composite particle precursor; and
(c) the negative electrode active material composite particle precursor is contacted with an alkaline solution to elute out the metal silicon and/or silicon oxide, thereby forming pores.

The method for producing the negative electrode active material composite particles of the disclosure by the method comprising steps (a) to (c) will now be explained by way of example.

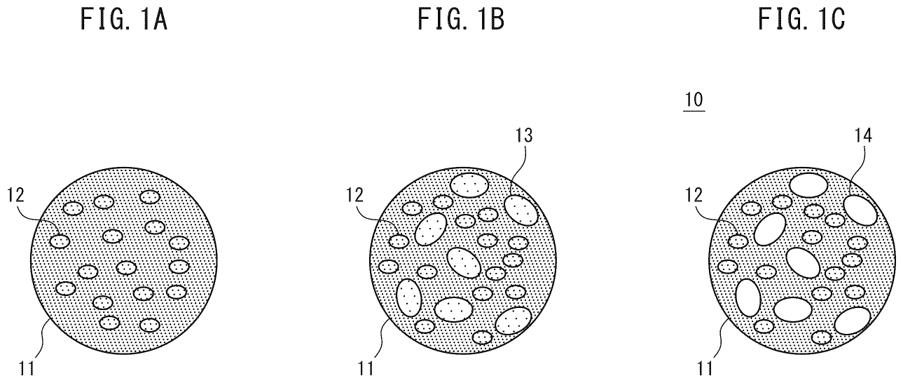

FIG. 1A shows a schematic diagram of the carbon-tin alloy complex obtained in step (a), FIG. 1B shows a schematic diagram of the negative electrode active material composite particle precursor obtained in step (b), and FIG. 1C shows a schematic diagram of the negative electrode active material composite particles 10 obtained in step (c). In FIG. 1, 11 represents a carbon material, 12 represents a tin alloy, 13 represents metal silicon and/or silicon oxide, and 14 represents pores.

The method of the disclosure may also include (a) mixing the carbon material, the metal that forms an alloy with tin, and tin, by a mechanical alloying method to obtain a carbon-tin alloy complex.

By adjusting the amounts of the metal and tin used in the method of the disclosure it is possible to adjust the composition of the tin alloy.

The mechanical alloying method may be, for example, a method of treating the starting materials with a ball mill at a specified rotational speed for a predetermined time period, under an inert gas atmosphere.

For example, by controlling the rotational speed and treatment time during treatment in this step it is possible to adjust the half-width of the tin alloy, and the pore volume proportion.

The aspect ratio of the negative electrode active material composite particles can be controlled by adjusting the size of the ball mill used.

The method of the disclosure may also include a step of (b) mixing a carbon-tin alloy complex with metal silicon and/or silicon oxide by mechanical alloying to obtain a negative electrode active material composite particle precursor.

The mechanical alloying may be carried out as described above in step (a). For example, by controlling the rotational speed and treatment time during treatment in this step it is possible to adjust the volume proportion and mean diameter of the pores, as well as the contents of the metal silicon, silicon oxide and silicon carbide in the negative electrode active material composite particles.

The method of the disclosure further includes a step of (c) contacting the negative electrode active material composite particle precursor with an alkaline solution to elute out the metal silicon and/or silicon oxide, thereby forming pores.

The method of contacting the negative electrode active material composite particle precursor with the alkaline solution may be a method of immersing the negative electrode active material composite particle precursor in the alkaline solution and stirring the mixture, for example.

By controlling the immersion and stirring time in this step it is possible to control the contents of the metal silicon, silicon oxide and silicon carbide in the negative electrode active material composite particles.

Using metal silicon and/or silicon oxide as the component for contact and elution in the alkaline solution in step (c) facilitates production of the negative electrode active material composite particles that further comprise metal silicon, silicon oxide and silicon carbide.

In step (b), another component that elutes out upon contact with an alkaline solution, in addition to the metal silicon and/or silicon oxide, may also be used to form pores in the negative electrode active material composite particles, if such a component is eluted out in step (c). Aluminum is an example of such a component.

The obtained negative electrode active material composite particles may also be classified using a mesh. In this case, the d90 of the negative electrode active material composite particles can be controlled by adjusting the opening sizes of the mesh used.

### <Negative Electrode Mixture>

The negative electrode mixture of the disclosure comprises negative electrode active material composite particles according to the disclosure. The negative electrode mixture may also optionally comprise a conductive aid and a binder. When the battery of the disclosure is a solid-state battery, the negative electrode mixture may also optionally comprise a solid electrolyte.

For the purpose of the disclosure, “mixture” means a composition that can form an active material layer either by itself or by further comprising other components. Moreover, the term “mixture slurry” means a slurry that comprises a dispersing medium in addition to the “mixture”, allowing it to form an active material layer by being coated and dried.

### <Negative Electrode Active Material Composite Particles>

The negative electrode active material composite particles are as described above.

The content of the negative electrode active material composite particles is not particularly restricted and may be set as appropriate in consideration of the desired battery capacity.

### <Other Components>

Other components used in addition to the negative electrode active material composite particles, such as conductive aids, binders and solid electrolytes, may be ones that are commonly used in batteries.

The contents of such components are not particularly restricted and may be set as appropriate in consideration of the desired properties.

### <Battery>

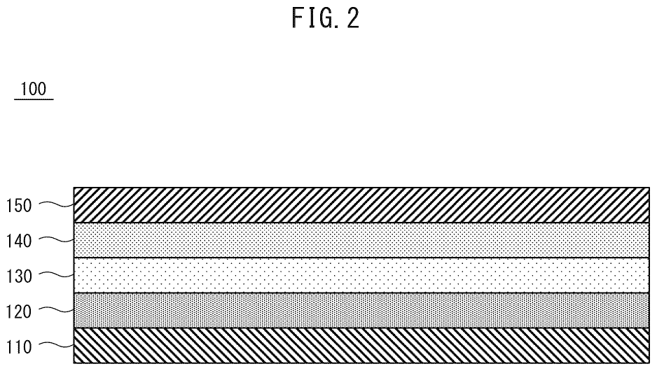

The battery of the disclosure has a negative electrode active material layer, the negative electrode active material layer comprising a negative electrode mixture of the disclosure. As in the example shown in FIG. 2, the battery 100 of the disclosure may have a negative electrode collector layer 110, a negative electrode active material layer 120 comprising a negative electrode mixture of the disclosure, an electrolyte layer 130, a positive electrode active material layer 140 and a positive electrode collector layer 150.

The battery of the disclosure may be a liquid battery or a solid-state battery, and especially a liquid battery. The term “solid-state battery” as used herein refers to a battery comprising at least a solid electrolyte as the electrolyte, where the solid-state battery may also employ a combination of a solid electrolyte and a liquid electrolyte as the electrolyte. Alternatively, the solid-state battery may be an all-solid-state battery, i.e. a battery comprising only a solid electrolyte as the electrolyte.

The battery of the disclosure may be a primary battery or a secondary battery, and is most especially a secondary battery.

The secondary battery may be a lithium ion secondary battery or a sodium ion secondary battery, for example.

The battery of the disclosure may be constrained by a constraining member such as an end plate, from both sides in the stacking direction of each layer. The constraining method may be, but is not limited to, a method utilizing the constraining torque of a bolt.

The elements composing the battery of the disclosure will now be described.

### <Negative Electrode Collector Layer>

The negative electrode collector layer may be formed of a known metal that can be used as a negative electrode collector layer for a battery.

### <Negative Electrode Active Material Layer>

The negative electrode active material layer may comprise a negative electrode mixture of the disclosure. The negative electrode active material layer may also have the negative electrode mixture itself formed in a laminar fashion.

The negative electrode active material layer can be produced, for example, by providing a mixture slurry comprising negative electrode active material composite particles and a dispersing medium, and coating the mixture slurry onto a substrate and drying and removing the dispersing medium.

The negative electrode active material composite particles are as described above.

The dispersing medium is also not particularly restricted. When the negative electrode mixture comprises a binder, the dispersing medium may be one that can dissolve the binder. N-Methyl-2-pyrrolidone (NMP) is an example of such a dispersing medium.

The method of providing the mixture slurry is not particularly restricted, and an example is a method of mixing each of the starting materials.

The substrate is also not particularly restricted and may be a negative electrode collector layer or release sheet, for example.

The method of coating the mixture slurry onto the substrate is not particularly restricted, and it may be appropriately set according to the viscosity of the slurry.

There are no particular restrictions on the method of drying and removing the dispersing medium. The drying conditions, such as the drying temperature and drying time, are not particularly restricted and may be appropriately set in consideration of the amount of dispersing medium used and the boiling point.

### <Electrolyte Layer>

The electrolyte layer may be one that is known as an electrolyte layer for use in batteries.

When the battery of the disclosure is a liquid battery, the electrolyte layer may be formed by impregnating a separator with an electrolyte solution.

When the battery of the disclosure is a solid-state battery, the solid electrolyte layer can function as the separator. The solid electrolyte layer comprises a solid electrolyte.

### <Positive Electrode Active Material Layer>

The positive electrode active material layer comprises a positive electrode active material, and may also optionally comprise a conductive aid and a binder. When the battery of the disclosure is a solid-state battery, the positive electrode active material layer may also optionally comprise a solid electrolyte.

The positive electrode active material may be one that is publicly known as a positive electrode active material for use in batteries.

The conductive aid, binder and solid electrolyte may be components that are publicly known for use in batteries.

### <Positive Electrode Collector Layer>

The positive electrode collector layer may be formed of a metal that is known for use as a positive electrode collector layer for a battery.

### <Remaining Construction>

The battery may have any of the constructions described above housed inside an exterior body. The exterior body used may be any publicly known type which is used as an exterior body for batteries. A plurality of batteries may also be optionally electrically connected and optionally stacked to form a battery assembly. In this case the assembled batteries may be housed inside a publicly known battery case. The battery may have an obvious type of construction, with the necessary terminals, for example. The form of the battery may be, for example, a coin, laminated (pouch), cylindrical or rectilinear form.

### EXAMPLES

### Example 1

### <Preparation of Negative Electrode Active Material Composite Particles>

A starting material comprising a carbon material, tin, and cobalt as the metal element forming the alloy with tin, was weighed out to a specified compositional ratio. The total mass of the starting materials was 15 g. In a 500 mL chromium steel container there were loaded 400 g of SUS balls and the weighed out starting materials, and after exchange with argon (Ar) gas, they were sealed and treated by mechanical alloying for 35 hours at a rotational speed of 250 rpm. A carbon-tin alloy complex was thus obtained.

After measuring out a prescribed amount of silicon oxide (SiO₂), it was loaded into the container and exchanged with Ar gas, after which it was sealed and treated by mechanical alloying for 2 hours at a rotational speed of 250 rpm. After treatment, the material in the container was recovered and classified using a mesh with 53 μm openings, and the mesh-passed powder was recovered. A negative electrode active material composite particle precursor was thus obtained.

The obtained negative electrode active material composite particle precursor was contacted with an alkaline solution to elute out the SiO₂. Specifically, 5 g of the negative electrode active material composite particle precursor was immersed for 8 hours in 250 mL of a 2 M NaOH solution while stirring. It was washed and filtered with 3 L of ion-exchanged water, and then vacuum dried at ordinary temperature. It was further classified with a mesh and the powder that passed through the mesh was collected. This yielded negative electrode active material composite particles with pores.

The composition of the obtained negative electrode active material composite particles was Co₃₆Sn₄₄C₂₀. For the tin alloy, quantitation was by energy dispersive fluorescent X-ray spectroscopy (EDX) and high-frequency inductively coupled plasma (ICP) emission spectroscopy. The carbon content was measured by a combustion method using a carbon/sulfur analyzer (CS meter).

The proportion of pores in the obtained negative electrode active material composite particles was 10.2 vol %. The proportion was measured using mercury porosimetry.

The aspect ratio of the obtained negative electrode active material composite particles was 1.56. The aspect ratio was calculated by dividing the longest width among the widths between the mutually opposite particle edges of each of the negative electrode active material composite particles, by the shortest width, for 5 particles in a cross-sectional SEM image of the particles.

The d90 of the obtained negative electrode active material composite particles was 9.29. The d90 value was calculated from the particle size distribution measured by laser diffraction using a SALD7500 by Shimadzu Corp.

### <Fabrication of Battery>

The obtained negative electrode active material composite particles, acetylene black (AB) as a conductive aid and polyvinylidene fluoride (PVdF) as a binder were weighed out in a mass ratio of 80/15/5 and dispersed in N-methyl-2-pyrrolidone (NMP). A negative electrode mixture slurry was thus prepared. The obtained negative electrode mixture slurry was coated onto a copper foil as a negative electrode collector layer and pressed, and then vacuum dried overnight at 120° C. to fabricate a negative electrode active material layer. The stack comprising the negative electrode active material layer and negative electrode collector layer obtained in this manner was provided as a test electrode.

Nickel-cobalt-manganese oxide (NCM) as a positive electrode active material, AB as a conductive aid and PVdF as a binder were weighed out to a mass ratio of 85/10/5 and dispersed in NMP. A positive electrode mixture slurry was thus prepared. The obtained positive electrode mixture slurry was coated onto an aluminum foil as a positive electrode collector layer and pressed, and then vacuum dried overnight at 120° C. to fabricate a positive electrode active material layer. The stack comprising the positive electrode active material layer and positive electrode collector layer obtained in this manner was provided as a counter electrode for the aforementioned test electrode.

The stacks for the test electrode and counter electrode were set facing each other across a polypropylene separator, and then impregnated with 1 M LiPF₆ in EC/DMC/FEC as the electrolyte solution and sealed to fabricate an evaluation cell.

### <Evaluation of Constraining Pressure Increase>

The evaluation was conducted in a thermostatic bath at 25° C., with a voltage range of 4.2-2.5 V and a 0.1 C rate. Charging was initiated with an initial pressure of 1 MPa, sandwiching a load cell (LCX-A-10KN by Kyowa Corp.) during charge-discharge. The increase in constraining pressure during initial charge was divided by the charge capacity to calculate the increase in constraining pressure with respect to capacity. An increase in constraining pressure is an increase in volume of the battery.

### Examples 2 to 6 and Comparative Examples 1 to 6

Batteries for Examples 2 to 6 and Comparative Examples 1 to 6 were obtained and evaluated in the same manner as Example 1, except for changing the size of the ball mill used to prepare the carbon-tin alloy complex and negative electrode active material composite particles and the type of mesh used to prepare the negative electrode active material composite particles. Using a large ball mill resulted in a low aspect ratio, while using small openings for the mesh resulted in a smaller d90.

The evaluation results for each Example are shown in Table 1. In Table 1, the values for constraining pressure increase are represented as relative values with respect to 100 as the value for Comparative Example 2.

TABLE 1

| | | | Constraining |
|---|---|---|---|
| | Aspect | d90 | pressure increase |
| | ratio | [μm] | [—] |
| Comp. Example 1 | 2.09 | 15.44 | 120 |
| Comp. Example 2 | 1.95 | 14.17 | 100 |
| Comp. Example 3 | 1.92 | 22.03 | 106 |
| Comp. Example 4 | 1.75 | 8.90 | 101 |
| Comp. Example 5 | 1.52 | 13.10 | 104 |
| Comp. Example 6 | 1.50 | 15.60 | 101 |
| Example 1 | 1.56 | 9.29 | 61 |
| Example 2 | 1.44 | 3.59 | 53 |
| Example 3 | 1.39 | 2.23 | 49 |
| Example 4 | 1.33 | 1.88 | 48 |
| Example 5 | 1.21 | 3.99 | 49 |
| Example 6 | 1.14 | 3.23 | 47 |

### REFERENCE SIGNS LIST

10 Negative electrode active material composite particles
11 Carbon material
12 Tin alloy
13 Metal silicon and/or silicon oxide
14 Pore
100 Battery
110 Negative electrode collector layer
120 Negative electrode active material layer
130 Electrolyte layer
140 Positive electrode active material layer
150 Positive electrode collector layer

1. Negative electrode active material composite particles comprising a carbon material and a tin alloy supported in the carbon material,
wherein the negative electrode active material composite particles have pores,
the aspect ratio of the negative electrode active material composite particles is 1.60 or lower, and
the d90 is 10.0 μm or smaller.

2. The negative electrode active material composite particles according to claim 1, wherein
the aspect ratio is 1.00 to 1.60, and
the d90 is 1.0 μm to 10.0 μm.

3. A negative electrode mixture comprising negative electrode active material composite particles according to claim 1.

4. A battery,
having a negative electrode active material layer,
wherein the negative electrode active material layer comprises a negative electrode mixture according to claim 3.

5. A method for producing negative electrode active material composite particles according to claim 1, the method comprising the following steps:
mixing the carbon material, tin, a metal that forms an alloy with tin, as well as metal silicon and/or silicon oxide by a mechanical alloying method, to obtain a negative electrode active material composite particle precursor, and
contacting the negative electrode active material composite particle precursor with an alkaline solution to elute out the metal silicon and/or silicon oxide, thereby forming pores.
